(19) United States
(12) Patent Application Publication
(10) Pub. No.: US 2005/0050998 A1
(43) Pub. Date: Mar. 10, 2005

(54) Bottle cork removal and installation tool

(76) Inventors: Richard Allen Reynolds, San Diego, CA (US); Julie Ann Boget, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/846,843

(22) Filed: May 14, 2004

Related U.S. Application Data
(60) Provisional application No. 60/471,473, filed on May 15, 2003.

(51) Int. Cl. B67B 7/18

(52) U.S. Cl. 81/3.29

(57) ABSTRACT

A bottle cork removal and insertion tool includes a shell formed with a center cylindrical partial bore within which is a hood that captures a cork from a bottle. The cork is positioned within the hood and the handle on an axial threaded shaft is rotated which advances the hood, and the captured cork, away from the bottle. A capturing plunger extends into the hood as the shaft is rotated in order to secure the cork in place in the hood. The threading on the shaft has a fine threaded portion to initiate the removal of the cork, and a coarse threaded portion to complete the removal in a single rotation. If desired, the cork can be positioned within the hood, the device positioned over a bottle top, and the cork can be re-inserted into the bottle by reversing the rotation of the threaded shaft.

### RELATED APPLICATION

The present application claims the benefit of priority to U.S. Provisional Patent Application Ser. No. 60/471,473 filed May 15, 2003, entitled “Bottle Cork Remover”, and currently co-pending.

### FIELD OF THE INVENTION

The present invention relates generally to bottle cork removers. The present invention is more particularly, though not exclusively, related to a bottle cork removal device that provides for the removal of a cork from a bottle, and is further useful to re-install the bottle cork into the bottle.

### BACKGROUND OF THE INVENTION

There are several bottle cork removal devices currently on the market. These devices, however, do not typically provide for the re-insertion of a cork into a bottle. For instance, a well-known bottle cork removal device includes a cork-screw that is twisted into the cork in a bottle and, by the application of force, the cork is pulled from the bottle. In these devices, however, it is often difficult to prevent the permanent damage to the cork during the removal process. Further, these damaged corks, even if re-inserted into a bottle, often do not seal the bottle sufficiently because of the damage sustained during the removal process.

In light of the above, it would be advantageous to provide a bottle cork opener that removes the cork from a bottle without damage, and re-inserts the cork back into the bottle for sealing the bottle. It would be further advantageous to provide for a bottle cork removal tool that is relatively easy to use without exerting substantial force on the bottle, cork, or the removal tool.

### SUMMARY OF THE INVENTION

The bottle cork removal and insertion tool of the present invention includes a shell formed with a center cylindrical partial bore within which is a hood that captures a cork from a bottle. Once the cork is positioned within the hood, a the handle on an axial threaded shaft is rotated which advances the hood, and the captured cork, away from the bottle. A capturing plunger extends into the hood as the shaft is rotated in order to secure the cork in place in the hood.

The threading on the shaft has a fine threaded portion, and a coarse threaded portion. The fine threaded portion is intended to facilitate the initiation of the removal of the cork where there is a larger force required to begin the removal of the cork from the bottle. Once the cork begins to move out of the bottle, the coarse threaded portion completes the cork removal within a single rotation of 360 degrees.

As the handle is rotated in a first direction, the threaded shaft moves away from the bottle to un-cork the bottle. If desired, the cork can be positioned within the hood, the device positioned over a bottle top, and the cork can be re-inserted into the bottle by reversing the rotation of the threaded shaft.

### BRIEF DESCRIPTION OF THE DRAWINGS

The novel features of this invention, as well as the invention itself, both as to its structure and its operation, will be best understood from the accompanying drawings, taken in conjunction with the accompanying description, in which reference characters refer to similar parts, and in which:

FIG. 1 is a perspective view of the bottle cork removal and insertion tool of the present invention and its design;

FIG. 2 is a front view of the bottle cork removal and insertion tool of the present invention and its design;

FIG. 3 is a back view of the bottle cork removal and insertion tool of the present invention and its design;

FIG. 4 is a left side view of the bottle cork removal and insertion tool of the present invention and its design;

FIG. 5 is a right side view of the bottle cork removal and insertion tool of the present invention and its design;

FIG. 6 is a bottom view of the bottle cork removal and insertion tool of the present invention and its design;

FIG. 7 is a top view of the bottle cork removal and insertion tool of the present invention and its design;

FIG. 8 is a front view of the bottle cork removal and insertion tool of the present invention in an alternative configuration with the hood in the raised position;

FIG. 9 is a front view of the bottle cork removal and insertion tool of the present invention as used to remove a cork from a bottle, and includes a shell containing a hood that captures the cork and, with the rotation of a handle, rotates a shaft and draws the hood and contained cork upwards removing the cork from the bottle;

FIG. 10 is a front view of the bottle cork removal and insertion tool shown in FIG. 9, with the hood shown in a partially raised configuration wherein the cork captured within the hood is partially removed from the bottle by the rotation of the handle and shaft;

FIG. 11 is a front view of the bottle cork removal and insertion tool shown in FIGS. 9 and 10, with the hood shown in its raised configuration wherein the cork captured within the hood is completely removed from the bottle and wherein the tool may be removed from the bottle for pouring from the bottle, and wherein the tool with the captured cork may be repositioned on the bottle, and the cork re-inserted into the bottle by the rotation of the handle in the opposite direction; and

FIG. 12 is a detailed and exploded view of the bottle cork removal and insertion tool showing the internal threaded shaft that provides for the advancement of the plunger to capture the cork within the hood.

### DETAILED DESCRIPTION

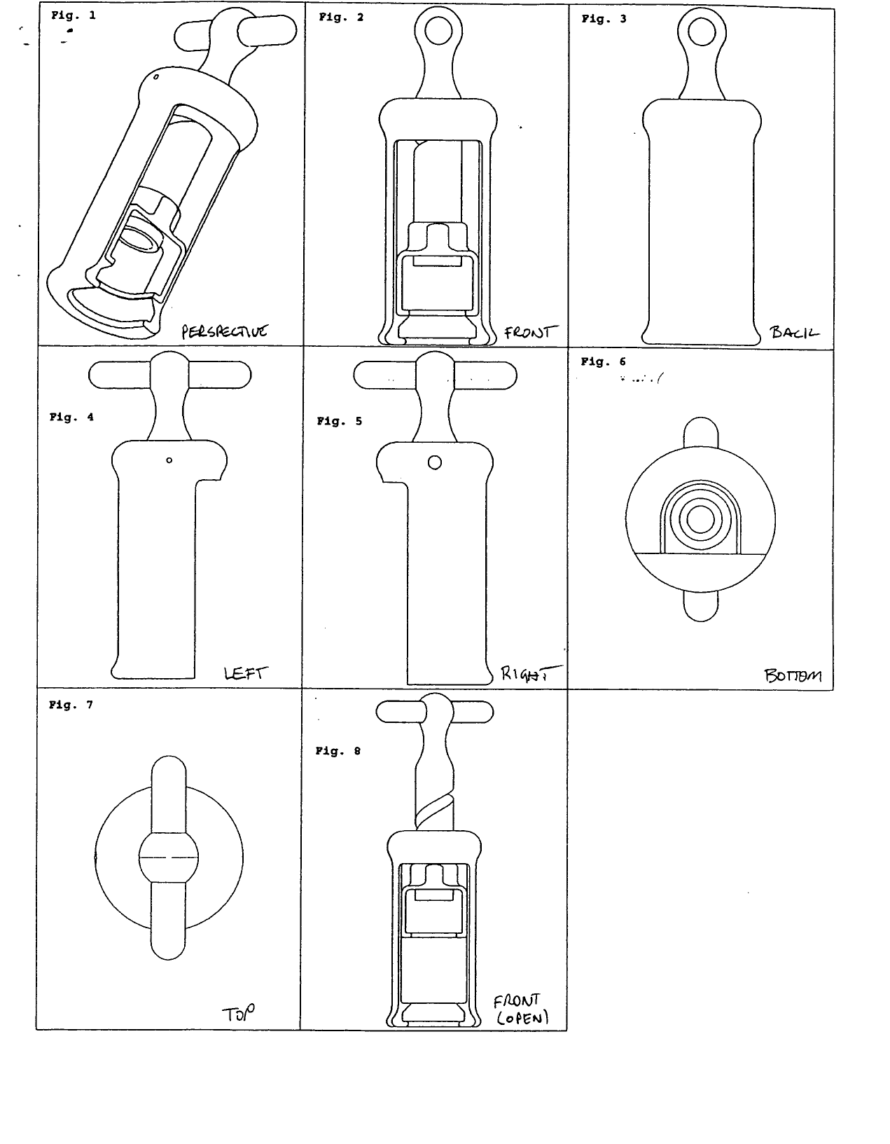

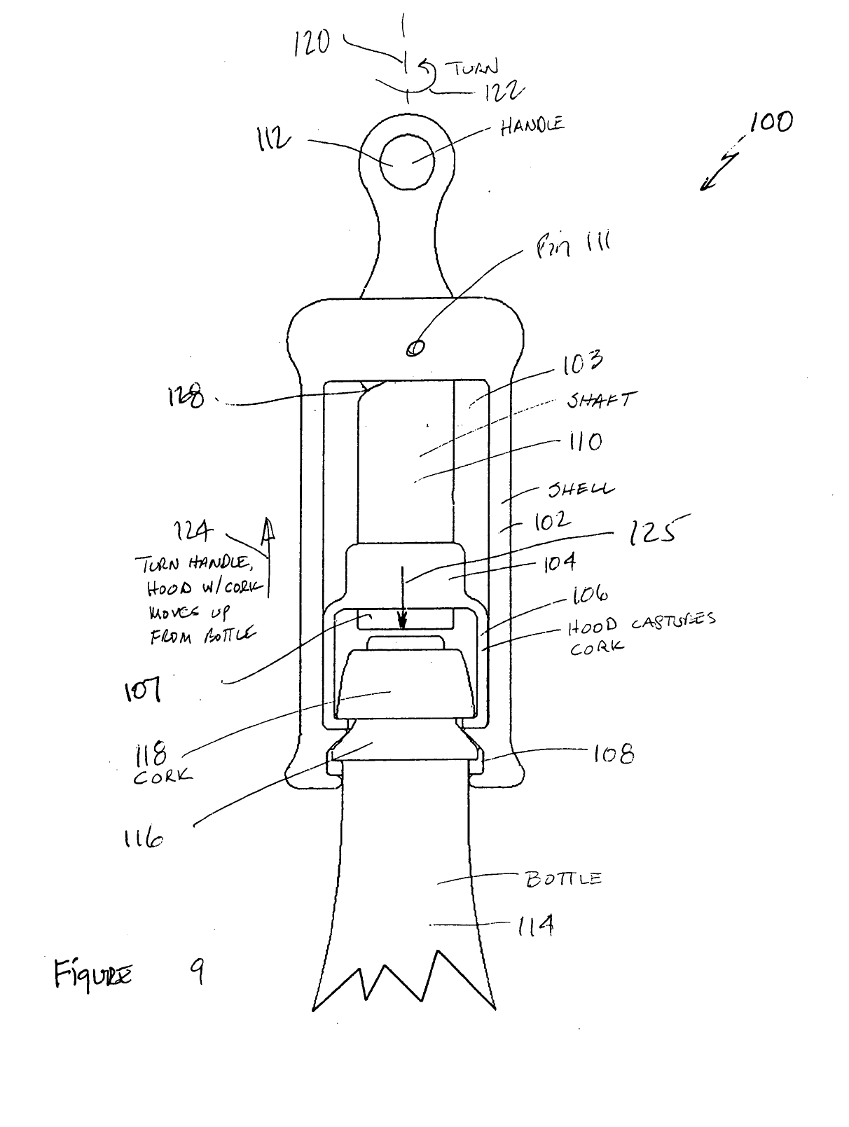

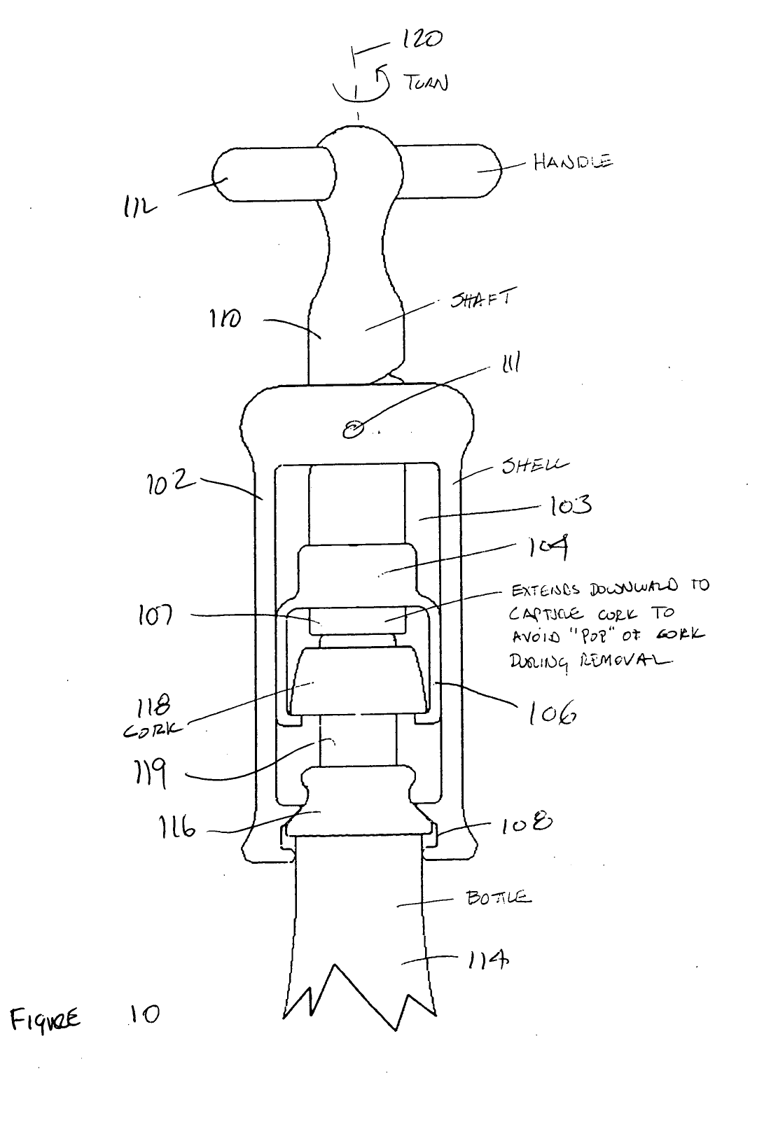

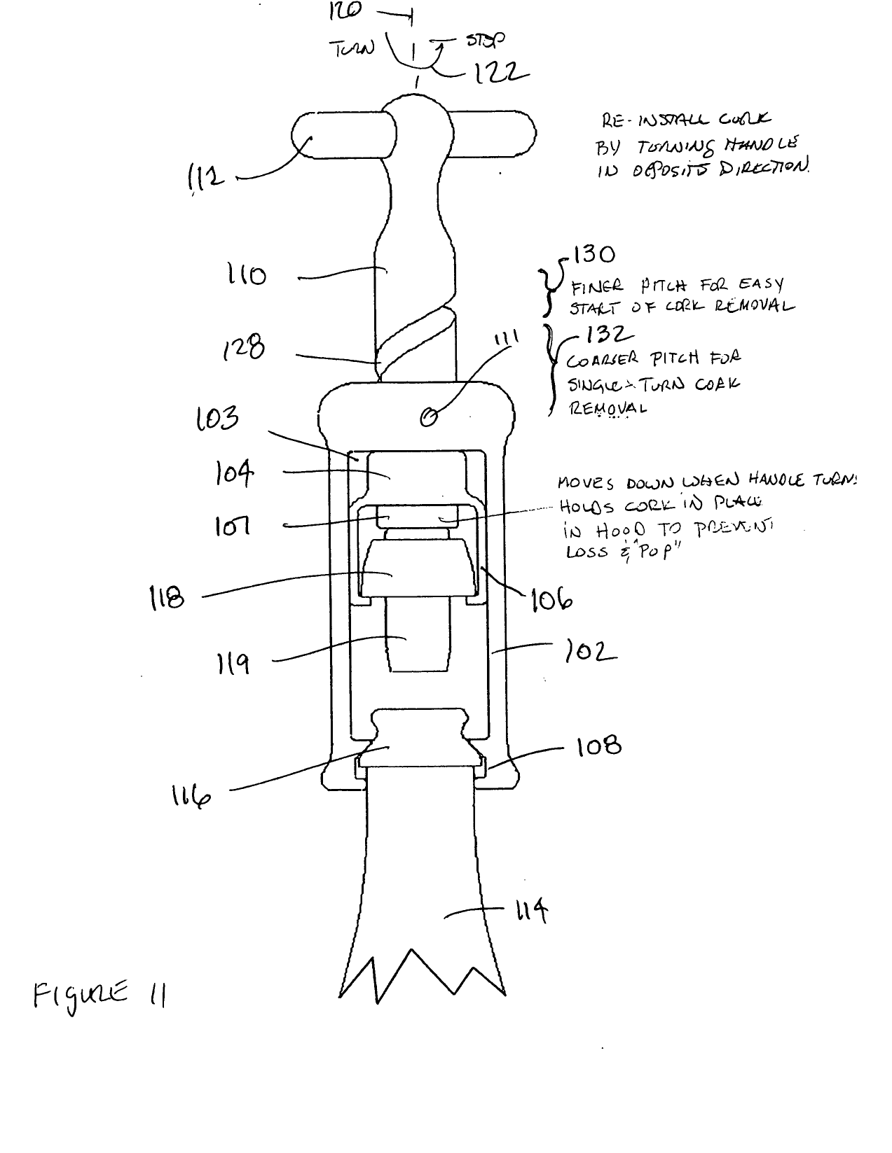

Referring initially to FIGS. 1 through 8, the bottle cork removal and insertion tool of the present invention is shown. Specifically, FIGS. 1 through 8 represent a preferred embodiment of the bottle cork removal and insertion tool of the present invention and its ornamental design.

Referring now to FIG. 9, a front view of the bottle cork removal and insertion tool of the present invention is shown and generally designated 100. The bottle cork removal and insertion tool of the present invention 100 includes a shell 102 formed with a center cylindrical partial bore 103 within which is a hood 104 having a cork-receiving opening 106 that captures a cork 118 from a bottle 114. A cork-capturing plunger 107 is within the opening 106 and, in use, captures the cork 118 within the opening 106.

A shaft 110 extends vertically from the hood 104 and through the shell 102 to a handle 112. As handle 112 is rotated about axis 120 in direction 122, the hood advances in direction 124 away from a bottle 114. Bottle 114 is held in place within shell 102 in a semi-circular groove 108 that captures a portion of the top of the bottle 114.

Once the cork 118 is positioned within the hood 104, the handle 112 on the axial threaded shaft 110 is rotated in direction 122 which advances the hood 104, and the captured cork 118, away from the bottle 114. As the threaded shaft 110 rotates, capturing plunger 107 extends in direction 125 into the opening 106 of the hood 104 to secure the cork 118 in place in the hood 104.

In a preferred embodiment, the thread 128 receives a pin 111 that extends through the shell 102 and into the thread 128. As the shaft 110 rotates, the pin 111 advances through the thread 128 to move the shaft 110 up in direction 124. As the handle 112 is rotated in a first direction 122, the threaded shaft 110 moves away from the bottle 114 in direction 124 to un-cork the bottle 114. If desired, the cork 118 may be positioned within the hood 104, the device 100 positioned over the opening to a bottle 114, and the cork 118 can be re-inserted into the bottle 114 by reversing the rotation 122 of the threaded shaft 110.

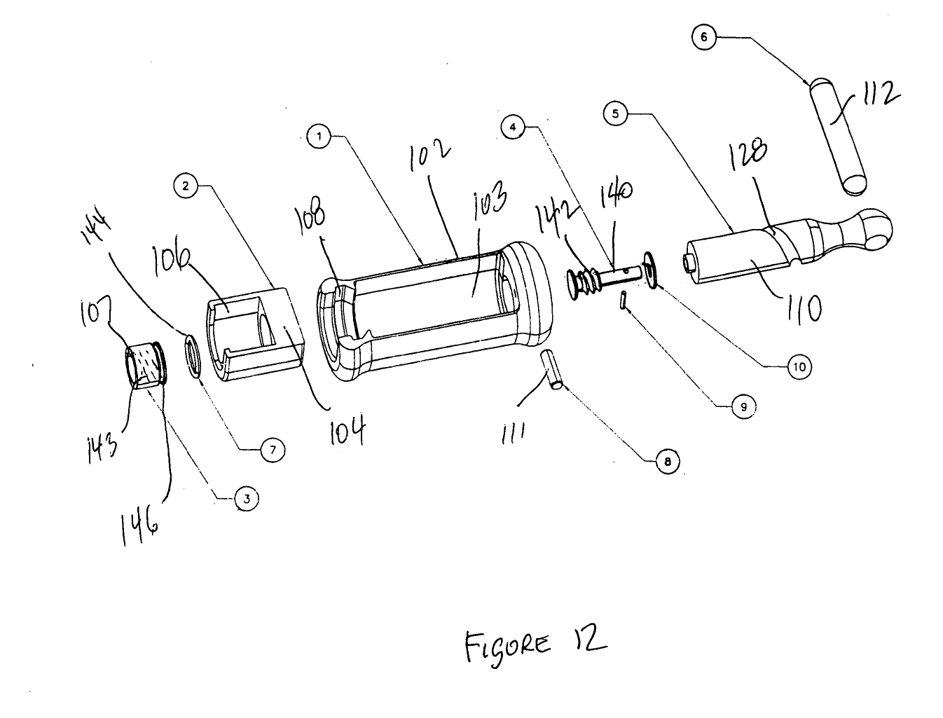

Referring to FIG. 10, the bottle cork removal and insertion tool 100 shown in a first configuration in FIG. 9, is shown in a second configuration wherein the hood 104 is in a partially raised position. More specifically, the cork 118 captured within the hood 104 and is partially removed from the bottle 114 by the rotation of the handle 112 and shaft 110. It is to be appreciated that the further the handle 112 is rotated in direction 122, the further the cork 118 is advanced in direction 124 and away from the bottle 114.

FIG. 11 provides a front view of the bottle cork removal and insertion tool of the present invention 100 as shown in FIGS. 9 and 10, with the hood 104 shown in its raised configuration wherein the cork 118 captured within the hood 104 is completely removed from the bottle 114. Once the cork 118 is fully removed from the bottle 114, the bottle 14 may be removed from semi-circular groove 108, and the tool may be removed from the bottle for pouring from the bottle. If desired, a cork 118 may be positioned in a tool 100, the tool 100 with a captured cork 118 may be repositioned over the top of a bottle 114, and the cork 118 re-inserted into the bottle 114 by the rotation of the handle 112 in the direction opposite direction 122.

In order to facilitate the removal of a cork that is securely held within a bottle, the threading 128 on the shaft 110 is formed to have a fine threaded portion 130, and a coarse threaded portion 132. The fine threaded portion 130 is intended to facilitate the initiation of the removal of the cork 118 from a bottle 114 where there is a larger force required to begin the removal of the cork 118 from the bottle 114. Once the cork 118 begins to move out of the bottle 114, the coarse threaded portion 132 completes the cork 118 removal within approximately a single rotation of 360 degrees.

An important safety feature of the bottle cork removal and insertion tool 100 of the present invention is the capturing of the cork 118 within hood 104. More specifically, by advancing capturing plunger 107 downward onto cork 118 prior to the complete removal of the cork 118 from bottle 114, there is no danger of the cork 114 “popping” out of the bottle as is common when opening bottles containing carbonated or pressurized fluids, such as Champagne.

The advancing of the plunger 107 to capture cork 118 is achieved by an internal thread formed on hood 104. The threads (not shown this Figure) are in the opposite direction of threads 128 such that as the hood 104 moves away in direction 124 from the bottle 114, the plunger 107 advances toward the bottle 114 and cork 118 in direction 125 in order to capture the cork 118 within the cork-receiving opening 106.

Referring now to FIG. 12, an exploded view of the bottle cork removal and insertion tool of the present invention is shown with all parts separated for clarity. As shown, an internal threaded shaft 140 extends from shaft 110 through hood 104 and into plunger 107. Threads 142 are sized to be received within complementary threads 143 within plunger 107 (shown in dashed lines). A friction ring 144 is positioned in groove 146 of plunger 107 such that plunger 107 is held snugly in hood 104 until plunger 107 moves in direction 125 sufficiently to strike cork 118. Once cork 118 is firmly captured in hood 104, friction ring 144 begins to slip allowing plunger 107 to rotate within hood 104 as shaft 110 continues to rotate as cork 118 is being removed.

While the bottle cork removal and insertion tool of the present invention as herein shown and disclosed in detail is fully capable of obtaining the objects and providing the advantages herein before stated, it is to be understood that it is merely illustrative of preferred embodiments of the invention and that no limitations are intended to the details of construction or design herein shown other than as described in the appended claims.

1. A bottle cork removal and insertion tool, comprising:
a shell formed with a center cylindrical partial bore;
a hood within said partial bore sized to captures a cork from a bottle;
a handle on an axial threaded shaft attached to said hood and extending through said shell wherein rotation of said handle advances the hood, and said captured cork, away from said bottle.

2. The bottle cork removal and insertion tool of claim 1, further comprising:
a capturing plunger axial to said shaft wherein said plunger extends into said hood as said shaft is rotated to secure said cork within said hood.

3. The bottle cork removal and insertion tool of claim 1, wherein said axial threaded shaft further comprises a fine threaded portion and a coarse threaded portion.

4. The bottle cork removal and insertion tool of claim 3, wherein said handle rotates approximately 360 degrees to completely remove said cork from said bottle.

5. The bottle cork removal and insertion tool of claim 1 wherein said shell is formed with a semicircular groove sized to receive a top of a bottle.

5. The bottle cork removal and insertion tool of claim 1 wherein said hood is formed with a cork-receiving opening sized to closely receive said cork.
